(19) United States
(12) Patent Application Publication
(10) Pub. No.: US 2025/0315689 A1
(43) Pub. Date: Oct. 9, 2025

(54) DETERMINING EDGE NODE CLIQUES VIA PROGRAMMATIC LABELLING ANALYSIS FOR FEDERATED LEARNING

(71) Applicant: Dell Products L.P., Round Rock, TX (US)

(72) Inventors: Vinicius Michel Gottin, Rio de Janeiro (BR); Herberth Birck Fröhlich, Florianópolis (BR); Paulo Abelha Ferreira, Rio de Janeiro (BR)

(21) Appl. No.: 18/628,543

(22) Filed: Apr. 5, 2024

(51) Int. Cl. G06N 3/098

(52) U.S. Cl. CPC G06N 3/098

(57) ABSTRACT

One example method includes transmitting labeling functions, by a central node to each edge node in a group of edge nodes, receiving, by the central node, a respective support matrix and agreement matrix from each of the edge nodes, constructing, by the central node, a distance matrix, using the support matrices and the agreement matrices received from the edge nodes, and using, by the central node, the distance matrix to cluster the edge nodes into one or more cliques.

### FIELD OF THE INVENTION

Embodiments of the present invention generally relate to clustering edge nodes so as to support federated learning. More particularly, at least some embodiments of the invention relate to systems, hardware, software, computer-readable media, and methods, for using programmatic labeling analysis to identify edge node cliques, based on their respective data distributions, that may be used in a federated learning process involving the edge nodes.

### BACKGROUND

Confidentiality of data, and/or the identity of the data owner, are significant considerations in some edge environments. For example, in a scenario in which each edge node collects local data, that data that must be kept private from other nodes. In such a scenario, a privacy-preserving approach for obtaining machine learning models trained with data from a plurality of nodes is federated learning (FL).

In such an environment obtaining labels for data at the edge nodes may be expensive, possibly prohibitively so, and/or subject to very large delays, such as due to the need for human revision/supervision with respect to assignment of the labels. Thus, approaches have been devised for the application of programmatic labelling, such that a few domain-specific labelling functions may be used to determine labels for a large set of labels.

In some such scenarios, the problem may occur that the data from multiple nodes may not share an underlying distribution. This is evidenced by a concrete use-case in which each edge node comprises a storage system. That is, while some storage arrays might have a different data distribution than others, it is also expected that some arrays might share similar data distributions. Although techniques such as FL tackle the problem of data privacy at the edge by communicating model gradients, performing FL in non-independent and identically distributed (i.i.d.) data setting is still an open problem.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example federated learning process.

FIG. 2 discloses aspects of a SNORKEL AI pipeline.

FIG. 3 discloses a representative environment for a federated learning setting.

FIG. 4 discloses an example of an application of programmatic labeling for a Federated Learning case, where labeling functions are deployed and applied at an edge node, according to one embodiment.

FIG. 5 discloses an approach for obtaining agreement and support matrices for pairs of rules at edge node E; according to one embodiment.

FIG. 6 discloses the communication of matrices A, S of each edge node to a central node, according to one embodiment.

FIG. 7 discloses an approach for obtaining a distance matrix H from edge node matrices A, S, according to one embodiment.

FIG. 8 discloses an approach for the determination of edge nodes cliques via clusterization based on the distance matrix H, according to one embodiment.

FIG. 9 discloses a method according to one embodiment.

FIG. 10 discloses an example computing entity configured and operable to perform any of the disclosed methods, processes, and operations.

### DETAILED DESCRIPTION OF SOME EXAMPLE EMBODIMENTS

Embodiments of the present invention generally relate to clustering edge nodes so as to support federated learning. More particularly, at least some embodiments of the invention relate to systems, hardware, software, computer-readable media, and methods, for using programmatic labeling analysis to identify edge node cliques, based on their respective data distributions, that may be used in a federated learning process involving the edge nodes.

One example embodiment is directed to a method for identifying cliques of edge nodes that may be employed as participants in a federated learning process. One example of such a method comprises the operations: deploying, by a central node to a group of edge nodes, a set of labeling functions; applying, by each edge node, the labeling functions to a local data sample;

based on application of the labeling functions, determining, by each edge node, respective support scores and agreement scores; generating, at each edge node, a support matrix and an agreement matrix; transmitting, by each edge node, its support matrix and agreement matrix to the central node; computing, by the central node based on the support matrices and agreement matrices received from the edge nodes, a distance matrix the identifies a distance between each pair of edge nodes; using the distance matrix to define cliques of the edge nodes. In an embodiment, the cliques may define respective federations, such as may be employed in a federated learning process for example.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that relationships among rules applied to local edge data may be used as a proxy for the distribution of that data. An embodiment may use programmatic data labeling schemes and analysis to identify node cliques that may employed in federated processes, such as federated learning for example. Various other advantages of one or more example embodiments will be apparent from this disclosure.

### A. Context for an Example Embodiment

### A.1 Federated Learning

Federated Learning (FL) is a machine learning technique where the goal is to train a centralized model while the training data remains distributed on many client nodes. Usually, the network connections and the processing power of such client nodes are unreliable and slow. Thus, the client nodes can collaboratively learn a shared machine learning model, such as a DNN (deep neural network) for example, while keeping the training data private on the client device, so the model can be learned without storing a huge amount of data in the cloud, or at a central node. Any process with many data-generating nodes may benefit from such an approach.

In the context of FL, a central node may be any machine with reasonable computational power that receives the updates from the client nodes and aggregates these updates on the shared model. A client node is any device or machine that contains data that will be used to train the machine learning model. Examples of client nodes, or edge nodes, include, but are not limited to, connected cars, mobile phones, data storage systems, and network routers.

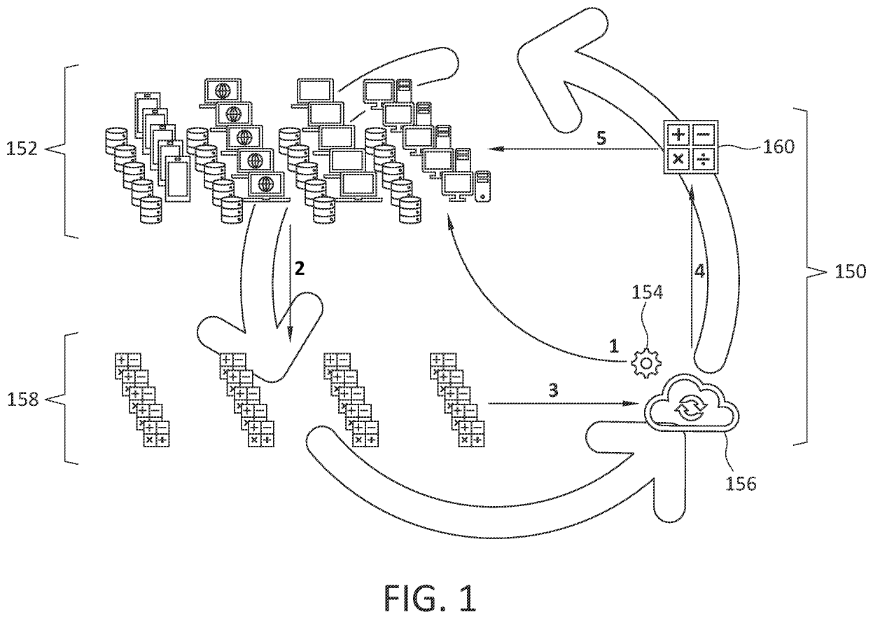

With attention to FIG. 1, an example method 100 for federated learning, in an architecture 150, is shown. The example method 100, comprising operations (1) through (5), may comprise the following iterations, or cycles: client nodes 152 download (1) the current model 154 from a central node 156—if this is the first cycle, the shared model 154 may be randomly initialized; (2) each client node 152 trains its instance of the model 154 using its local data during a user-defined number of epochs; (3) the model updates 158 generated by the client nodes 152 are sent from the client nodes 152 to the central node 154—in an embodiment, these model updates 156 may comprise vectors containing the gradients; (4) the central node 156 aggregates these vectors and updates the shared model 160; (5) and, if the predefined number of cycles N is reached, finish the training—otherwise, return to (1).

### A.2 Programmatic Labeling

Programmatic labeling is a data-centric approach created by SNORKEL.AI to increase the quality of automatic labeling by using labeling functions and a small portion of true labels (or even no labels) to label observations at scale in a traceable way. Aspects of the SNORKEL.AI approach are disclosed in “A. Ratner, S. Bach, H. Ehrenberg, J. Fries, S. Wu and C. Ré, ‘SNORKEL: Rapid Training Data Set Creation with Weak Supervision,’ The VLDB Journal, vol. 29, 2020,” which is incorporated herein in its entirety by this reference.

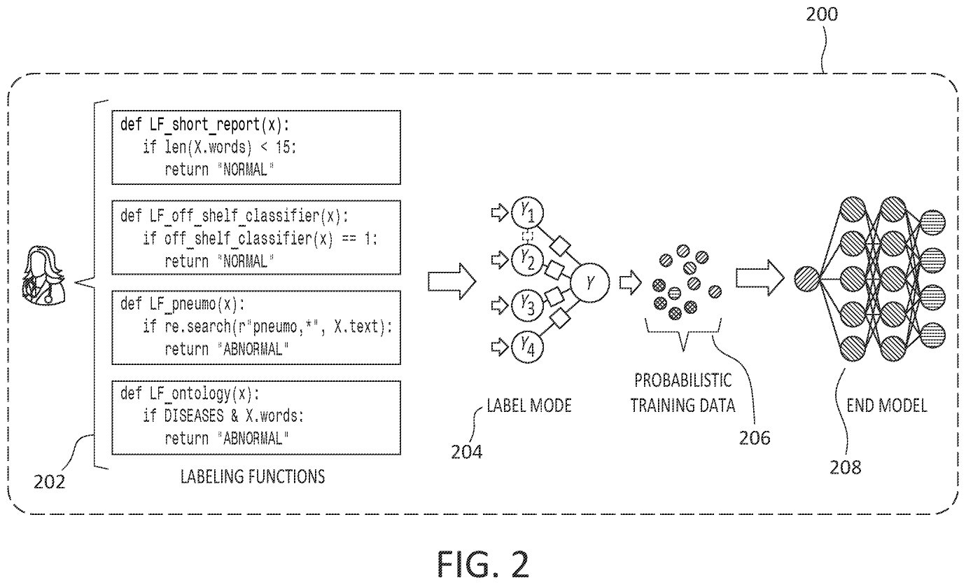

FIG. 2 discloses aspect of the SNORKEL.AI pipeline, denoted at 200. The pipeline 200 begins with labeling functions 202 that can be heuristics created by subject matter experts or even trained models. These functions are applied on the dataset, and they may conflict, have superposition, or provide abstains. A label model 204 is operates to incorporate all labeling functions outputs for the same observation into a single, probabilistic label. However, this label model 204 lacks generalization, so the probabilistic labeled data 206 is used to train a second model 208. This second model 208 is a discriminative model with generalization capabilities.

One example embodiment is concerned with the output of the labeling functions 202, such that, in an embodiment, neither a label model 204 nor end model 208 training are required. In an embodiment, a labeling function 202 may comprise a heuristic, such as:

$$Label = \{ \begin{matrix}Class , & if condition is True \\ Abstain , & otherwise\end{matrix}$$

Such a labeling function 202 may comprise an output of a trained model, trained using semi, or weak, supervision, or may comprise a query from a database, as in a case of distant supervision.

### B. Overview of Aspects of an Example Embodiment

With the foregoing context in view, one example embodiment may generate and use a heuristic to cluster ‘cliques’ of nodes, that is, nodes with likely identically distributed data, while maintaining fidelity to applicable privacy guarantees and requirements. The approach according to one embodiment comprises leveraging statistics of the application of labeling functions over the local datasets at each edge node, as in programmatic labelling approaches, as a distance function for the clustering the edge nodes.

An approach according to one example embodiment may proceed as follows. A central node deploys a known set of labeling functions to each edge node. Each edge node then applies each of the labeling functions to its respective locally available sample, obtaining a generative model that attributes labels to each sample based on the results. It is noted that this application of programmatic labelling is particularly useful for scenarios in which data at the edge nodes would otherwise be unlabeled. Thus, this programmatic labeling functionality may be existing in some domains, and, in such cases, an embodiment does significant additional computational overhead, that is, beyond what the pre-existing programmatic labeling functionality already imposes.

One example embodiment does not so much leverage the resulting labelling model produced at each node, but rather assesses the agreements, and possibly other relations as well, between pairs of rules, that is, labelling functions, at each node. The rules may be used to compose, locally, at the edge node, a structure, namely, a support matrix and an agreement matrix, respectively comprising support scores and agreement scores, which may then be compressed and communicated to the central node.

The central node then compares the sets of such structures received to determine which edge nodes are likely fit to compose a clique. This determination may rely on the fact that nodes at which the labeling functions apply at similar frequencies, and with similar agreements, may be likely to present similar underlying distributions in their data. The resulting cliques May then be assumed as separate federations for a hierarchical FL process, or as starting cliques for an adaptive FL process that adjusts cliques as process progresses through training rounds.

Thus, an embodiment may, among other things, operate to leverage an application of programmatic labelling, that is, labeling functions applied at the edge nodes, for the determination of cliques of nodes with close data distributions. The cliques may be used in a federated learning process, but that is not required.

### C. Detailed Discussion of Aspects of an Example Embodiment

An embodiment may be implemented in connection with a typical Federated Learning environment, although that is note required. In such an environment, the privacy concerns regarding the data at each node prevent sharing the actual samples between nodes and/or with the central node. Network limitations for the transference of data to and from edge nodes may also apply.

C.1 Example FL environment

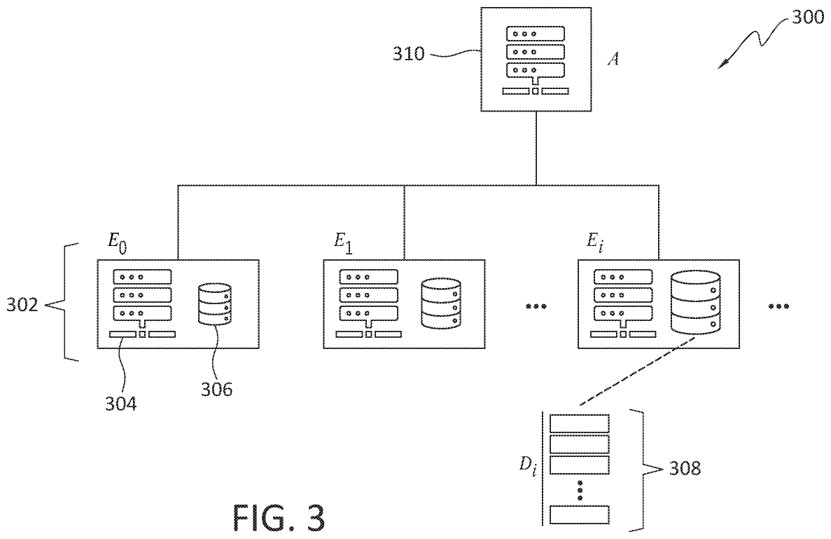

With attention now to FIG. 3, an example of a federated learning environment 300 is disclosed. As shown there, each edge node 302 may comprise local resources such as processors 304 and some data storage 306. A dataset 308 of locally available data samples may be stored in the data storage 306. Each of the edge nodes 302 may be configured to communicate data and metadata to/from a central node 310.

In many cases labels are required for supervised learning training of a model at the edge nodes 302. Typically, true, or ‘golden, data labels must be obtained at the edge node 302 directly. This may be costly, since a human may have to review each sample and assign, that is, label, a class/score to the sample. Obtaining true labels may be impractical due to the volume or frequency of the samples, such as in the example case of a model that uses as input the accelerometer data from smartphones to predict movement events. Finally, obtaining true labels may implicate privacy concerns. For example, regulations may prevent inspection of health or medical data from patients.

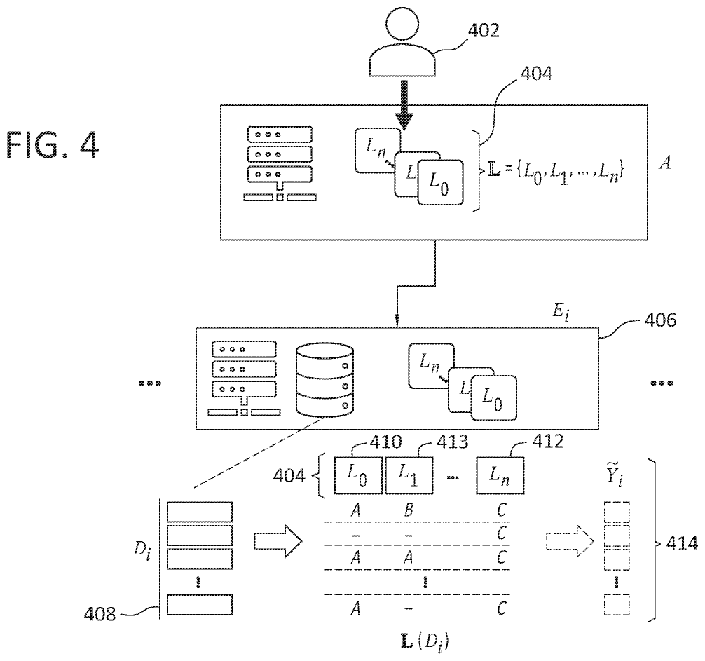

In view of scenarios such as those just mentioned, an embodiment may comprise a combination of programmatic labeling and FL, as disclosed in FIG. 4. Particularly, FIG. 4 discloses an application of PL (programmatic labeling) for a FL case, with labeling functions deployed and applied at the edge node.

### C.2 Application of Programmatic Labeling

In the example of FIG. 4, an expert user 402 determines a set 404 of labeling functions [symbol] , which are sent to each edge node 406. The labeling functions are applied over local data samples 408. Each labeling function either abstains, indicated by ‘-’ in the example, or yields a class, such as A, B, or C in the example of FIG. 4. Note that as used herein, a labeling function, or rule, is considered to have been ‘applied’ when the use of the labeling function yields a class such as A, B, or C. On the other hand, when the labeling function abstains, such that no class is assigned to a data sample, then that labeling functions is considered not to have been applied.

Some labeling functions, such as L₀ 410 and Lₙ 412 may be single-class, that is, they may either abstain, or vote a single class, such as A or C, respectively. In other instances, there may be cases in which labeling functions are multi-class, such as L₁ 413 in the example, which abstain, or output one of A or B. Example embodiments of the invention may comprise the use of single-class labeling functions, and/or multi-class labeling functions. FIG. 4 further discloses that, from the assigned classes, tentative labels Y̅ᵢ 414 may be obtained for the data samples in Dᵢ, such as for the training of a model via supervised learning, or for creating a generative model for future labeling.

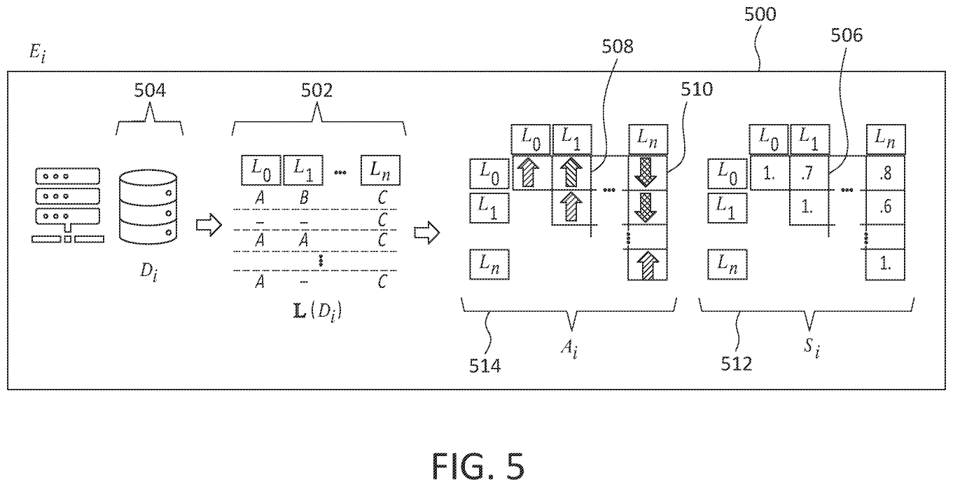

An embodiment may leverage the application of labeling functions, such as the examples in FIG. 4, over all data samples, that is, the respective data samples of all the edge nodes, to help determine which set(s) of edge nodes comprise representative and coherent data, that is, to determine a data distribution at, and among, each of the edge nodes. More specifically, an embodiment may use (1) the relative support, that is, how frequently the rules are applied, and (2) the agreements of pairs of rules at each edge node, as a “proxy” for the underlying data distribution of that edge node. The first stage of an approach according to an embodiment is disclosed in FIG. 5.

### C.3 Agreement and Support Matrices

In particular, FIG. 5 discloses obtaining the agreement and support matrices for pairs of rules at edge node E; 500. Recalling from the earlier discussion herein of the PL approach that each labelling function L 502 may (1) abstain or (2) assign a tentative class for each sample. In this latter case (2), the labeling function is said to have been ‘applied.’ Note that as used herein, a ‘labeling function’ may comprise, and apply, a ‘rule’ that specifies circumstances under which a label will, or will not, be applied to a data sample 504. An embodiment may compute, at each edge node Eᵢ 500, and for each pair of rules Lₐ, L_{b}, the following:
A support Sᵢ^{a,b}—a score representing how frequently the two rules, or labeling functions, are applied together. Formally:

$${S}_{i}^{a , b} = \frac{\vert \{ d ∈ {D}_{i} \vert {L}_{a} ( d ) \neq abstain , {L}_{b} ( d ) \neq abstain \} \vert}{\vert {D}_{i} \vert}$$

An agreement Aᵢ^{a,b}—a score representing how frequently the two rules, or labeling functions, agree on the assigned class for the samples. Formally:

$${A}_{i}^{a , b} = \frac{\vert \{ d ∈ {D}_{i} \vert {L}_{a} ( d ) = {L}_{b} ( d ) \} \vert}{{S}_{i}^{a , b}}$$

With respect to the foregoing, it is noted that the support Sᵢ^{a,b} means support is calculated for a pair of rules Lₐ, L_{b}, and is based on whether rules Lₐ and L_{b} are ‘applied,’ that is, those rules do not ‘abstain,’ for the same samples. Accordingly, the support is 1.0 if Lₐ and L_{b} are both always applied to the same samples in dataset Dᵢ. Otherwise, the support will be a number between 0.0 and 1.0 representing the proportion of samples in Dᵢ for which both rules were applicable at the same time.

As shown in FIG. 5 (right hand side), that the main diagonal (upper left to lower right) in Sᵢ comprises all 1.0 values since, by definition, each rule is being compared with itself. By way of contrast, the support (506) Sᵢ^{0,1} is 0.7, meaning that for 70% of the samples in dataset Dᵢ, both rules L₀ and L₁ ‘applied’ or, put another way, neither of the rules abstained for that portion of the samples.

Further the ‘agreement’ (508) Aᵢ^{0,1} between rules L₀ and L₁ is reasonable, meaning that those rules are frequently applied together, to about 70% of the data samples 504 in the example of FIG. 5, and those rules mostly ‘agree’ on the class to be assigned to those data samples 504. By way of contrast, consider the relation between rules L₀ and Lₙ, which have even higher support (Sᵢ^{0,n} is 0.8) but they disagree with each other, as shown at 510 (downward arrow), meaning that those rules assign different respective classes to the data samples 504. It is noted that while the agreements are indicated pictorially in FIG. 5, by formulation the agreements also range in value from 0 to 1 (inclusive), that is, the proportion of data samples 504 for which the two rules assign the same class.

With continued reference to the example of FIG. 5, it can be seen that two single-class labeling functions, such as Lₐ, L_{b}, will always completely agree (agreement=1.0) if they deal with the same class, and will always completely disagree (agreement=0.0) if they deal with different classes. With respect to single class labeling rules, assume, for example, a rule Lx that either abstains or assigns class A to a sample. If that rule is compared to another rule Ly that is also single-class and either abstains or assigns class A, then the support and the agreement are the same thing. As a final example, compare L_{X} to a rule L_{w} that is single-class but for another class, meaning it either abstains or assigns class B to the samples, then the agreement between these two rules is always zero, that is, they do not, and cannot, ever vote for the same class.

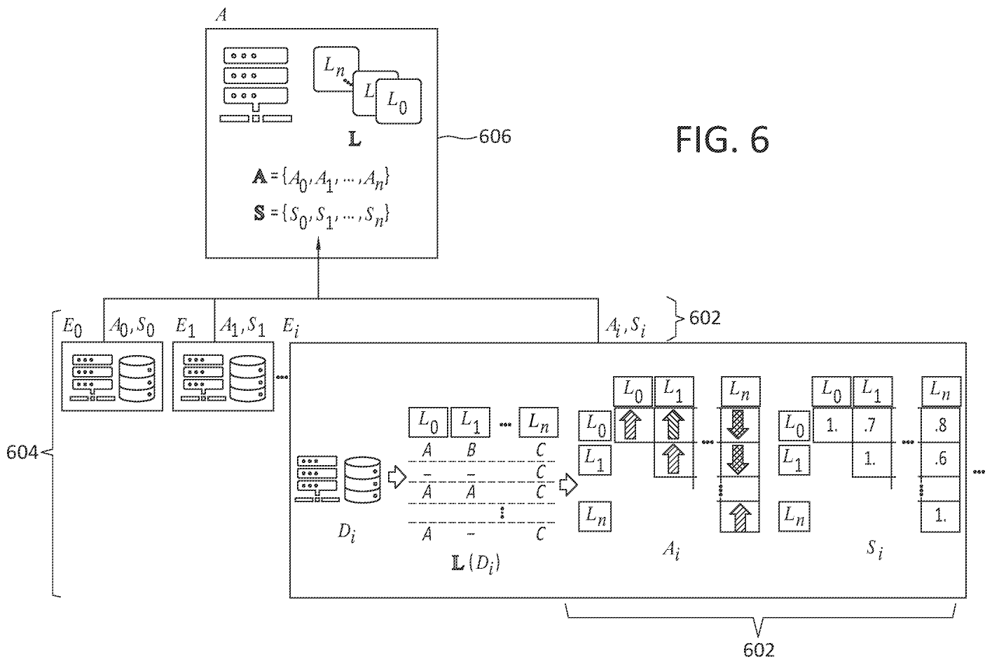

With the foregoing in view, and continued reference to the example of FIG. 5, the various support and agreement scores for all pairs of rules may be used to assemble a support matrix Sᵢ (512) and an agreement matrix Aᵢ (514), respectively, at the edge node Eᵢ 500. As noted earlier herein, two single-class labeling functions Lₐ, L_{b} will always agree completely if they deal with the same class, and will always disagree completely if they deal with different classes. In domains where only single-class labeling functions exist, Aᵢ≡Sᵢ. In the most-general case, however, some labeling functions will be multi-class, and both Aᵢ and Sᵢ may be required. In some cases only Sᵢ is necessary. Note that in the example of FIGS. 5 and 6, since the matrices are symmetric, only the upper portion, that is the portion above an imaginary line extending from L₀ down to Lₙ, is indicated. After the matrices for each edge node have been created, they may be communicated to a central node, as disclosed in FIG. 6.

### C.4 Communication of Matrices

In particular, FIG. 6 discloses the communication of matrices A, S (602) of each node 604 to a central node 606. That is, the central node 606 obtains sets A and S of the matrices 602 from the edge nodes 604. In an embodiment, the matrices A, S (602) may indexed such that the index matches the index of the edge node 604 in a data structure at the central node 606, by any suitable registry mechanism that may be available such as, but not limited to, a trivial indexed list of nodes 604. This communication of the matrices A, S (602) may employ any reasonable compression mechanism for reduced strain on the networking overhead.

It is noted that while these example matrices A, S (602) encode some information of the representativeness of classes in each dataset, they do not comprise any information that would enable reconstruction of the data samples themselves at the central node 606, or at any other node. As such, an embodiment may be effective in preserving the privacy of the data samples at each of the edge nodes.

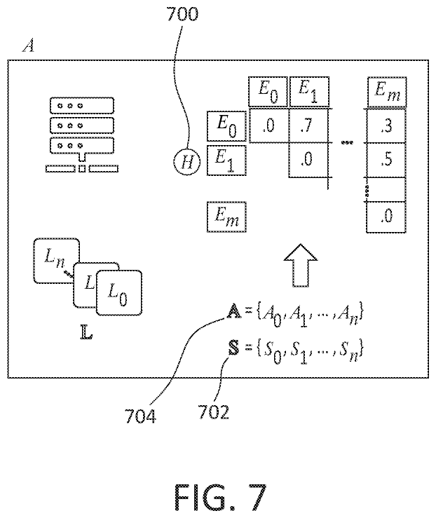

At the central node 606, the matrices in [symbol] and in [symbol] may combined to form a single distance matrix H. An example of this stage is shown in FIG. 7.

C.5 Obtaining a Distance Matrix from [symbol] , [symbol] .

In an embodiment, the distance matrix H (700) may comprise a distance between each pair of edge nodes Eᵢ, Eⱼ and may be constructed with the matrices in [symbol] (702) and in [symbol] (704). An embodiment may assume that the maximum number of participant nodes m is predetermined. The computation of the distance matrix H may be based on any applicable matrix distance function. One embodiment may employ the function:

$$d ( X , Y ) = {\sum }_{i = 1}^{m} {\sum }_{j = i}^{m} \vert {X}_{i j} - {Y}_{i j} \vert$$

This example function is both symmetric, and satisfies the conditions of a metric space.

As noted earlier herein, in certain cases, the matrix Aᵢ of each edge node is not necessary. In this case, the distance matrix H is configured such that each element:

$${H}_{i j} = d ( {S}_{i} , {S}_{j} ) .$$

Otherwise, in the general case that also includes the matrices in [symbol] (704), an embodiment may compute each element of the distance matrix H as follows:

$${H}_{i j} = α d ( {S}_{i} , {S}_{j} ) + ( 1 - α ) d ( {A}_{i} , {A}_{j} ) .$$

Here, α represents a relative weight given for the support of the application of the pairs of rules over the agreements.

In one embodiment, each matrix Sᵢ may be used to filter the corresponding matrix Aᵢ, indicating that such embodiment will consider only the agreements between pair of rules when they were sufficiently applicable in tandem. In this case, an embodiment may assign an agreement of zero (0) to the pairs of rules for which the support is below a predetermined threshold, and the distance matrix H is such that Hᵢⱼ=d(A′ᵢ,A′ⱼ), wherein A′ᵢ is the matrix Aᵢ where elements

$${A}_{i x y}^{′} = \{ \begin{matrix}0 , & if {S}_{ixy} < k \\ {A}_{ixy} , & otherwise\end{matrix} .$$

### C.6 Determination of Edge Node Cliques

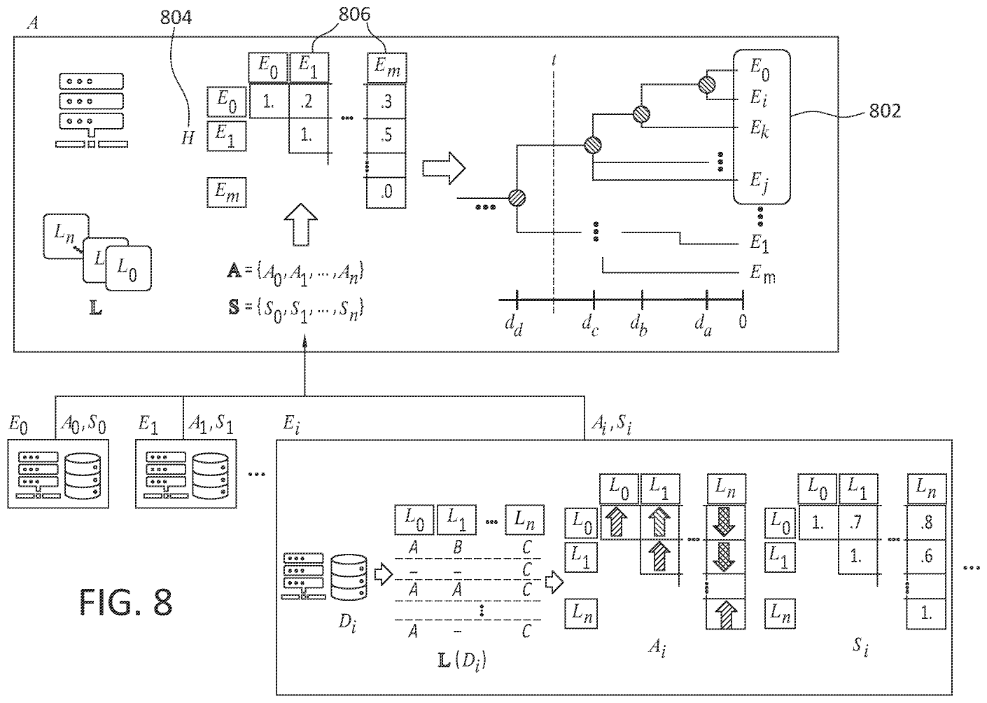

With the distance matrix H at hand, an embodiment may then operate to cluster the edge nodes, based on their relative pairwise distances, and then obtain the “clique(s)” of edge nodes as clusters. Different clustering algorithms may be applied. The example of FIG. 8 discloses a resulting dendrogram by single-linkage agglomerative hierarchical clustering, such as may be obtained using the approach disclosed in “M. J. Angur, Jarman, Angur Mahmud. Hierarchical cluster analysis: Comparison of single linkage, complete linkage, average linkage and centroid linkage method, 2020,” which is incorporated herein in its entirety by this reference. Particularly, FIG. 8 discloses the determination of edge node cliques 802 using clusterization based on the distance matrix H 804.

Depending on the clustering approach applied, and no particular clustering approach is required in any embodiment, each resulting cluster may be determined as an appropriate clique of nodes for a federated learning approach, and/or for other processes. If hierarchical clustering is applied, a threshold of maximum distance between the clusters t may be determined. An example of such a case is disclosed in FIG. 8, where the nodes E₀, Eᵢ, Eₖ and Eⱼ are considered a clique 802, as the height d, for the cluster is below threshold t, and the remaining nodes E₁ and Eₘ (806) are not. The resulting edge node cliques 802 may be used for FL approaches.

### D. Example Methods

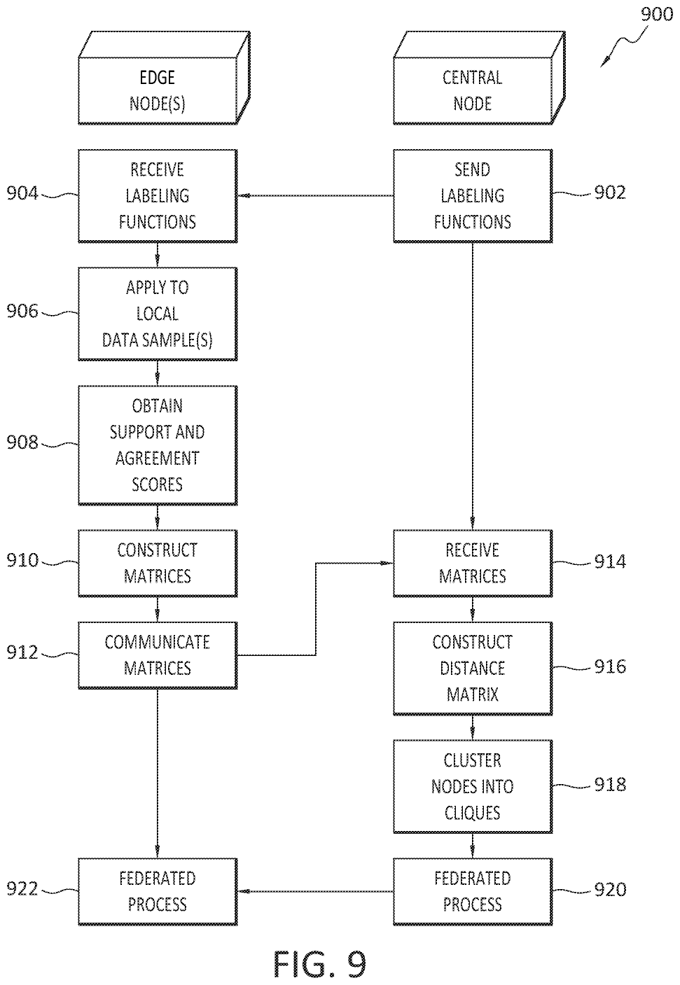

It is noted with respect to the disclosed methods, including the example method of FIG. 9, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 9, a method 900 according to one embodiment is disclosed. In an embodiment, the method 900 may be performed by one or more edge nodes in cooperation with a central node.

The example method 900 may begin when a central node sends 902 one or more labeling functions to each of the edge nodes in a group of edge nodes. In an embodiment, the labeling functions may be provided to the central node by a user, or directly to the edge nodes by a user. No particular configuration is required however.

The edge nodes may then receive 904 the labeling functions, and apply 906 the labeling functions to one or more respective local data samples. It is noted that no exchange of data samples occurs between the edge nodes, or between any edge node and the central node. As such, privacy of the local data samples of the edge nodes is preserved. Note further that as used here, ‘apply 906’ indicates that each of the labeling functions determines whether, for each data sample, to either abstain from assigning a class, or to assign a tentative class.

Based on the application, or abstention, as applicable, by the labeling functions, the edge nodes may the obtain 908 support scores, and agreement scores. The support scores and the agreement scores may then be used to construct 910 respective support matrices and agreement matrices for each of the edge nodes. These matrices may then be communicated 912 by the edge nodes to the central node.

After receipt 914 of the support matrices and agreement matrices from each of the edge nodes, the central node may then construct 916 a distance matrix, using the support matrices and the agreement matrices. The distance information, which may comprise respective distances between each pair of edge nodes, in the distance matrix may then be used by the central node to cluster 918 the edge nodes into one or more cliques.

In an embodiment, the cliques may participate in a federated process 920/922 with the central node. One example of such a federated process is a machine learning (ML) model training process.

### E. Further Example Embodiments

Following are some further example embodiments of the invention. These are presented only by way of example and are not intended to limit the scope of the invention in any way.

Embodiment 1. A method, comprising: transmitting labeling functions, by a central node to each edge node in a group of edge nodes; receiving, by the central node, a respective support matrix and agreement matrix from each of the edge nodes; constructing, by the central node, a distance matrix, using the support matrices and the agreement matrices received from the edge nodes; and using, by the central node, the distance matrix to cluster the edge nodes into one or more cliques.

Embodiment 2. The method as recited in any preceding embodiment, wherein information in the support matrices and the agreement matrices serves as a proxy for respective underlying sample data distributions at each of the edge nodes in one of the cliques.

Embodiment 3. The method as recited in any preceding embodiment, wherein, for one of the edge nodes, the support matrix for that edge node comprises a score that indicates how frequently each pair of the labeling functions are applied together to a local data sample of that edge node.

Embodiment 4. The method as recited in any preceding embodiment, wherein, for one of the edge nodes, the agreement matrix for that edge node comprises a score that indicates how frequently each pair of the labeling functions agree on a class assigned to a local data sample of that edge node.

Embodiment 5. The method as recited in any preceding embodiment, wherein one of the labeling functions is a single-class labeling function.

Embodiment 6. The method as recited in any preceding embodiment, wherein one of the labeling functions is a multi-class labeling function.

Embodiment 7. The method as recited in any preceding embodiment, wherein the distance matrix indicates respective distances between each pair of the edge nodes.

Embodiment 8. The method as recited in any preceding embodiment, wherein each of the labeling functions is configured to either assign a class to respective data samples of the edge nodes, or abstain from assigning a class to the respective data samples of the edge nodes.

Embodiment 9. The method as recited in any preceding embodiment, wherein the support matrices and the agreement matrices, individually and collectively, do not include enough information to enable reconstruction, of respective data samples of the edge nodes, at the central node, or at any of the edge nodes.

Embodiment 10. The method as recited in any preceding embodiment, wherein the support matrix of one of the edge nodes is used to filter the agreement matrix of that edge node.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

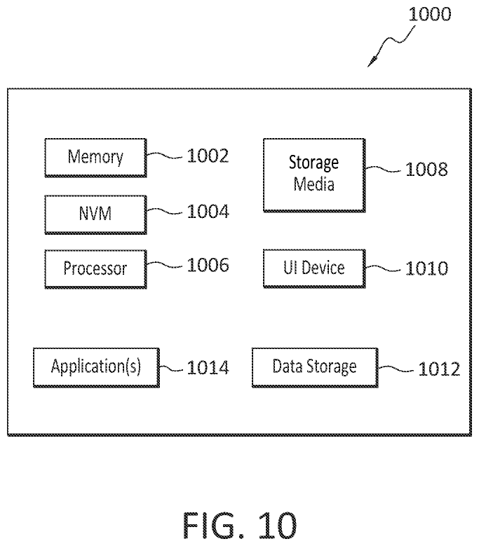

With reference briefly now to FIG. 10, any one or more of the entities disclosed, or implied, by FIGS. 1-9, and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
transmitting labeling functions, by a central node to each edge node in a group of edge nodes;
receiving, by the central node, a respective support matrix and agreement matrix from each of the edge nodes;
constructing, by the central node, a distance matrix, using the support matrices and the agreement matrices received from the edge nodes; and
using, by the central node, the distance matrix to cluster the edge nodes into one or more cliques.

2. The method as recited in claim 1, wherein information in the support matrices and the agreement matrices serves as a proxy for respective underlying sample data distributions at each of the edge nodes in one of the cliques.

3. The method as recited in claim 1, wherein, for one of the edge nodes, the support matrix for that edge node comprises a score that indicates how frequently each pair of the labeling functions are applied together to a local data sample of that edge node.

4. The method as recited in claim 1, wherein, for one of the edge nodes, the agreement matrix for that edge node comprises a score that indicates how frequently each pair of the labeling functions agree on a class assigned to a local data sample of that edge node.

5. The method as recited in claim 1, wherein one of the labeling functions is a single-class labeling function.

6. The method as recited in claim 1, wherein one of the labeling functions is a multi-class labeling function.

7. The method as recited in claim 1, wherein the distance matrix indicates respective distances between each pair of the edge nodes.

8. The method as recited in claim 1, wherein each of the labeling functions is configured to either assign a class to respective data samples of the edge nodes, or abstain from assigning a class to the respective data samples of the edge nodes.

9. The method as recited in claim 1, wherein the support matrices and the agreement matrices, individually and collectively, do not include enough information to enable reconstruction, of respective data samples of the edge nodes, at the central node, or at any of the edge nodes.

10. The method as recited in claim 1, wherein the support matrix of one of the edge nodes is used to filter the agreement matrix of that edge node.

11. A non-transitory storage medium having stored therein instructions that are executable by one or more hardware processors to perform operations comprising:
transmitting labeling functions, by a central node to each edge node in a group of edge nodes;
receiving, by the central node, a respective support matrix and agreement matrix from each of the edge nodes;
constructing, by the central node, a distance matrix, using the support matrices and the agreement matrices received from the edge nodes; and
using, by the central node, the distance matrix to cluster the edge nodes into one or more cliques.

12. The non-transitory storage medium as recited in claim 11, wherein information in the support matrices and the agreement matrices serves as a proxy for respective underlying sample data distributions at each of the edge nodes in one of the cliques.

13. The non-transitory storage medium as recited in claim 11, wherein, for one of the edge nodes, the support matrix for that edge node comprises a score that indicates how frequently each pair of the labeling functions are applied together to a local data sample of that edge node.

14. The non-transitory storage medium as recited in claim 11, wherein, for one of the edge nodes, the agreement matrix for that edge node comprises a score that indicates how frequently each pair of the labeling functions agree on a class assigned to a local data sample of that edge node.

15. The non-transitory storage medium as recited in claim 11, wherein one of the labeling functions is a single-class labeling function.

16. The non-transitory storage medium as recited in claim 11, wherein one of the labeling functions is a multi-class labeling function.

17. The non-transitory storage medium as recited in claim 11, wherein the distance matrix indicates respective distances between each pair of the edge nodes.

18. The non-transitory storage medium as recited in claim 11, wherein each of the labeling functions is configured to either assign a class to respective data samples of the edge nodes, or abstain from assigning a class to the respective data samples of the edge nodes.

19. The non-transitory storage medium as recited in claim 11, wherein the support matrices and the agreement matrices, individually and collectively, do not include enough information to enable reconstruction, of respective data samples of the edge nodes, at the central node, or at any of the edge nodes.

20. The non-transitory storage medium as recited in claim 11, wherein the support matrix of one of the edge nodes is used to filter the agreement matrix of that edge node.
